(19) United States
(12) Patent Application Publication
(10) Pub. No.: US 2024/0267686 A1
(43) Pub. Date: Aug. 8, 2024

(54) SYSTEMS AND METHODS FOR HYBRID INTERCOM, VIDEO MONITORING, AND ACCESS CONTROL OPERATIONS

(71) Applicant: Verkada Inc., San Mateo, CA (US)

(72) Inventors: Michael Douglas LYONS, San Francisco, CA (US); David Ye ZHAI, San Francisco, CA (US); Sergey Vladimirovich PHILIPPOV, Oakland, CA (US); Erik Christopher OLSEN, San Carlos, CA (US); Anubhav SINGLA, San Francisco, CA (US); Darshan Jayeshbhai PATEL, Sunnyvale, CA (US)

(21) Appl. No.: 18/434,450

(22) Filed: Feb. 6, 2024

Related U.S. Application Data
(60) Provisional application No. 63/483,478, filed on Feb. 6, 2023.

(51) Int. Cl. H04R 27/00

(52) U.S. Cl. CPC H04R 27/00

(57) ABSTRACT

An apparatus includes a processor and a memory operably coupled to the processor. The memory stores instructions to cause the processor to receive a call request via an intercom operably coupled to the processor and further receive at least one of (1) badge event data via an access control device operably coupled to the processor, or (2) video data via a camera operably coupled to the processor, the intercom, the access control device, and the camera being co-located at an ingress location. Additionally, the instructions cause the processor to cause display, via a graphical user interface operably coupled to the processor, of a depiction of a modified call routing sequence that is generated based on a predefined call routing sequence and the at least one of the badge event data or the video data.

### CROSS-REFERENCE TO RELATED APPLICATION

This application claims priority to and the benefit of U.S. Provisional Patent Application No. 63/483,478, filed Feb. 6, 2023 and titled “Systems and Methods for Hybrid Intercom, Video Monitoring, and Access Control Operations,” the content of which is incorporated herein by reference in its entirety.

### FIELD

The present disclosure generally relates to smart routing of intercommunication device communications, and more specifically, to integrated/hybrid systems and methods for leveraging intercommunication device communications within the operations of a building or region.

### BACKGROUND

An intercommunication device, or “intercom,” is a communications system typically used within a building or collection of buildings, that functions independently of a public switched telephone network (PSTN).

### SUMMARY

In some embodiments, an apparatus includes a processor and a memory operably coupled to the processor. The memory stores instructions to cause the processor to receive, from an intercom system, a call request and receive, in response to the call request, routing data. The memory also stores instructions to cause the processor to modify, based on the routing data, a first call routing sequence associated with a first set of receivers to produce a second call routing sequence associated with a second set of receivers. Additionally, the memory stores instructions to cause the processor to cause, in response to the call request and based on the second call routing sequence, a message to be sent to a compute device associated with a receiver from the second set of receivers.

In some embodiments, a non-transitory, processor-readable medium stores instructions that, when executed by a processor, cause the processor to receive a call request associated with a caller. The instructions also cause the processor to generate a receiver identifier based on at least one of (1) badge event data associated with a receiver or (2) video data associated with the caller. Additionally, a modified call routing sequence is generated based on the receiver identifier and a predefined call routing sequence that is different from the modified call routing sequence. The modified call routing sequence includes the receiver identifier. The instructions also cause the processor to cause a message to be sent to a compute device associated with the receiver based on the modified call routing sequence.

In some embodiments, an apparatus includes a processor and a memory operably coupled to the processor. The memory stores instructions to cause the processor to receive a call request via an intercom operably coupled to the processor and further receive at least one of (1) badge event data via an access control device operably coupled to the processor, or (2) video data via a camera operably coupled to the processor, the intercom, the access control device, and the camera being co-located at an ingress location. Additionally, the instructions cause the processor to cause display, via a graphical user interface operably coupled to the processor, of a depiction of a modified call routing sequence that is generated based on a predefined call routing sequence and the at least one of the badge event data or the video data.

### BRIEF DESCRIPTION OF THE DRAWINGS

FIGS. 1A-1B are diagrams of a hybrid/“smart” intercom system for hybrid intercom, video monitoring, and access control operations, according to some embodiments.

FIG. 2 is a diagram of a unified calling interface for a smart intercom system, according to an embodiment.

FIG. 3 shows a call sequence diagram for a smart intercom system, according to an embodiment.

FIG. 4 shows a call sequence events listing generated by a smart intercom system, according to an embodiment.

FIG. 5 shows an expanded view of a call sequence event, according to an embodiment.

FIG. 6 shows an example call sequence scheduling interface for a smart intercom system, according to an embodiment.

FIGS. 7-9 are example user interface depicting functionalities of a smart intercom system, according to some embodiments.

FIG. 10 shows a flow diagram illustrating a method 1000 for using a smart intercom system to modify a call routing sequence, according to an embodiment.

FIG. 11 shows a flow diagram illustrating a method 1100 for using a smart intercom system to cause a message to be sent based on at least one of (1) badge event data associated with a receiver or (2) video data associated with the caller, according to an embodiment.

FIG. 12 shows a flow diagram illustrating a method 1200 for using a smart intercom system to cause display of a depiction of a modified call routing sequence, according to an embodiment.

### DETAILED DESCRIPTION

Some embodiments set forth herein include a hybrid/“smart” intercom system for hybrid intercom, video monitoring, and/or access control operations. The smart intercom system (or “smart intercom” and/or “intercom system”) can be implemented in software and/or hardware, and configured to intelligently route calls based on one or more predefined sequences of steps (also referred to herein as “sequencing directives” or “call routing sequences”), each of which can reference one or multiple receivers (e.g., within a given networked communications system, such as for a building or geographic region). The smart intercom can prioritize some receivers over others, for example based on the sequencing directives and/or based on data associated with one or more of: the incoming call(s), data associated with one or more video recording systems associated with the networked communications system, data associated with one or more access control systems (e.g., door access control systems) associated with the networked communications system, or data associated with one or more receivers associated with the networked communications system. Incoming calls to an intercom can be initiated by a “visitor” or other user who is physically present at the intercom at the time of the call.

In some embodiments, a hybrid/“smart” intercom system is configured to perform hybrid intercom, video monitoring, and access control operations. The smart intercom system can intelligently route incoming calls based on predefined sequences of steps, each referencing one or multiple receivers (e.g., by including one or more receiver identifiers) within a networked communications system. The smart intercom can prioritize some receivers over others based on the predefined sequences of steps (which can be based on, for example, time of day, day of week, etc.). The smart intercom can also dynamically modify intercom call sequences based on data associated with the incoming call, data associated with one or more video recording systems, data associated with one or more access control systems, and/or data associated with one or more of the receivers (e.g., status data indicating availability of the one or more receivers, such as “here” and “away” statuses). Incoming calls to the smart intercom system can be initiated by a “visitor” or other user who is physically present at the intercom at the time of the call. For example, the visitor can cause a call request to be received by the smart intercom to initiate the incoming call by pressing a button operably coupled to the smart intercom, by being positioned within a field of view of the one or more video systems configured to detect the visitor (e.g., using machine vision models), and/or the like. Alternatively or in addition, an individual other than the visitor (e.g., a receptionist and/or the like) can initiate a call to a visitor who is within the field of view of the one or more video systems and/or in proximity to the smart intercom.

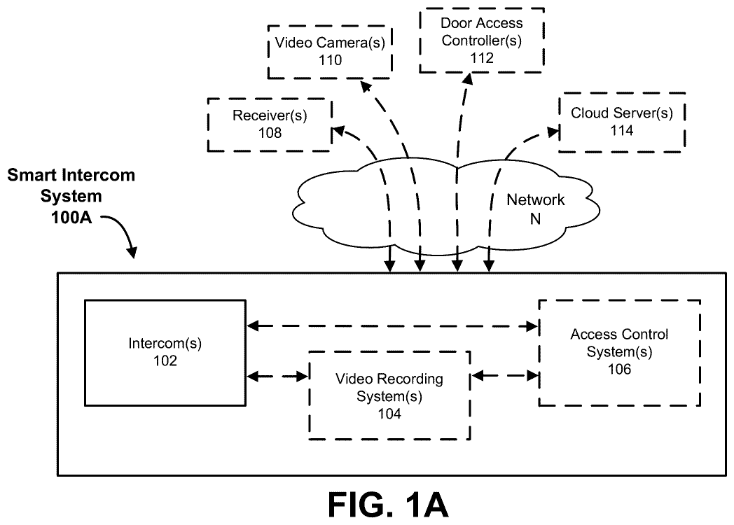

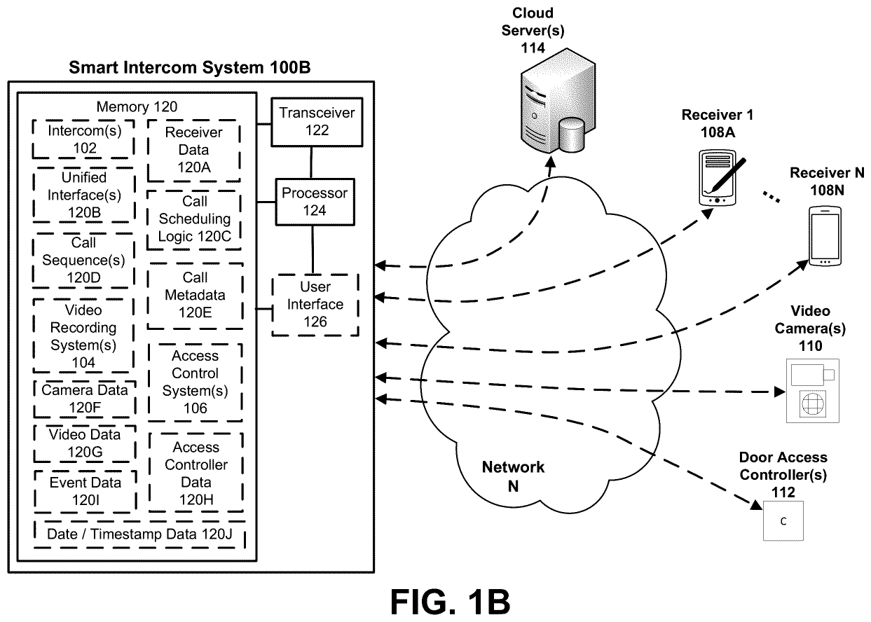

FIGS. 1A-1B are diagrams of a hybrid/“smart” intercom system and/or apparatus for hybrid intercom, video monitoring, and access control operations, according to some embodiments. As shown in FIG. 1A, a smart intercom system 100A includes one or more intercoms 102 (implemented in software and/or hardware), and optionally includes one or more video recording systems 104 and/or one or more access control systems 106. Alternatively or in addition, the smart intercom system 100A may include and/or be in communication via a wireless and/or wired telecommunications network “N” with one or more receivers 108, video cameras 110, door access controllers 112, and/or cloud servers 114. Data generated by the smart intercom system 100A may be stored locally “at rest” (optionally encrypted) and/or may be transmitted to the one or more cloud servers 114 for storage thereon (optionally encrypted).

As shown in FIG. 1B, in some embodiments, a smart intercom system 100B (e.g., similar to the smart intercom system 100A of FIG. 1A) includes a memory 120 operably coupled to a transceiver 122, a processor 124, and optionally a user interface 126 (e.g., a graphical user interface (GUI), a display panel, etc.). The processor 124 is operably coupled to the transceiver 122 and, if present, the user interface 126. The memory 120 stores one or more of: one or more intercoms 102 (e.g., having audio (microphone) and/or video (camera) capability), one or more video recording systems 104, one or more access control systems 106, receiver data 120A, one or more unified interfaces 120B, call scheduling logic 120C, one or more call sequences 120D, call metadata 120E, camera data 120F (e.g., video camera identifiers, etc.), video data 120G (e.g., streamed video and/or archived video), access controller data 120H (e.g., door access controller identifiers), event data 120I (e.g., logs of historical intercom calls, video data, access controller data, call metadata, etc.), or date/timestamp data 120J. As described herein, at least one of the call metadata 120E, video data 120G, event data 120I, and/or date/timestamp data 120J can be referred to as call request routing data and can cause a modification to and/or selection of a call sequence. The smart intercom system 100B is optionally in operable communication, via network N, with one or more of receivers 108A through 108N, video camera(s) 110, door access controller(s) 112, and/or cloud servers 114. In some embodiments, the network N includes multiple networks, including one or more wired networks (e.g., the public switched telephone network (PSTN) system, which may be limited to circuit-based telephone networks), one or more wireless local area networks (LANs), one or more wireless wide area networks (WANs), the internet, one or more data-based networks (e.g., voice over internet protocol (VOIP), session initiation protocol (SIP), etc.), etc. Alternatively or in addition, in some embodiments, the intercom(s) 102 (e.g., located at controlled-access doors) are hard-wired directly within the smart intercom system and, optionally, are not in wireless or wired communication with any device outside the smart intercom system 100B. Alternatively or in addition, in some embodiments, the smart intercom system 100B may be hard-wired to some receivers (e.g., land-line phones) and in wireless communication (e.g., via the internet) with other receivers (e.g., cell phones, tablets, laptops, etc.).

### Call Sequencing

In some embodiments, an intercom (e.g., the intercom(s) 102 of FIG. 1B) or smart intercom (e.g., the smart intercom system 100B of FIG. 1B) is configured to perform a predefined series or sequence of call steps. Each call step can include communication with a wide variety of different kinds of receivers (e.g., the receiver(s) 108A through N of FIG. 1B), such as phone(s), mobile software applications (“apps”), desk receivers, etc. For example, the intercom system may be configured to call a first set of one or more receivers in a first call step, and if no receiver answers, continue to a next call step in the predefined sequence of call steps. In some implementations, if no call is answered during any predefined call step from the predefined sequence of call steps, the caller may automatically be presented with a pre-programmed “away” message.

In some embodiments, an intercom/smart intercom includes, and is configured to call multiple different types of receivers using, a unified (e.g., a single) calling interface, implemented in software and/or hardware, thereby creating a consistent experience across the receivers. In other words, the unified calling interface on the intercom can be configured to call many different receiver types but treat them all identically (e.g., using a similar/common syntax, format, etc.), such that the call sequence and associated call scheduling logic are intuitive from a user's perspective. In some implementations, first party applications and the public switched telephone network (PSTN) system may be called simultaneously, or overlapping in time, (e.g., within a common given call step) via a unified interface that interacts with different calling backends while maintaining a single user interface.

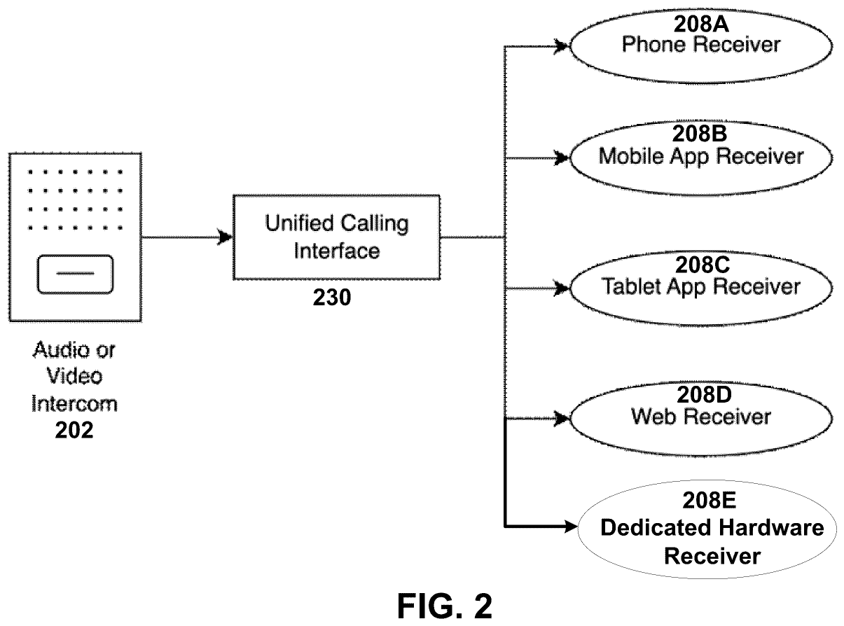

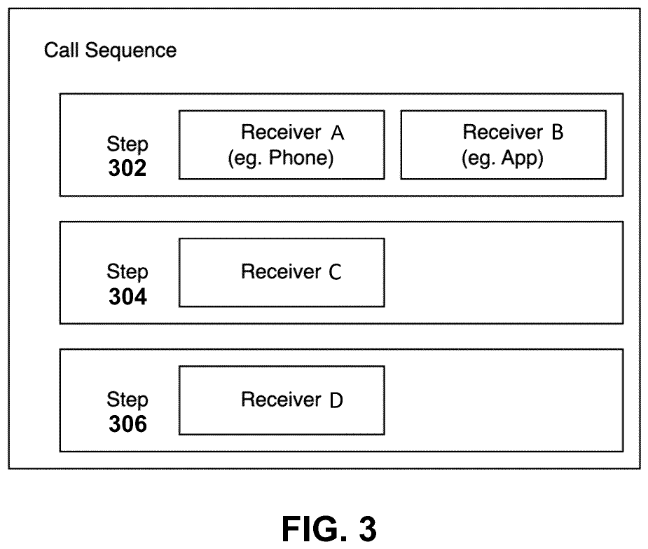

FIG. 2 is a diagram of an example unified calling interface for a smart intercom system, according to an embodiment. As shown in FIG. 2, the unified calling interface 230 serves as an intermediary between the audio and/or video intercom 202 and a plurality of receivers—namely, a phone receiver 208A, a mobile app receiver 208B, a table app receiver 208C, a web receiver 208D, and optionally one or more dedicated hardware receivers 208E (e.g., a desk station tablet, dedicated and/or fixed kiosk, and/or the like). The unified calling interface 230 can implement one or more call sequences. A call sequence can include any number of steps, and a step can include references to (i.e., can invoke) any number of receivers. Receivers within a step and/or a call sequence can be of any type. Call sequences may be predefined (e.g., by a user) or automatically generated by a smart intercom system. Regardless of whether predefined or automatically generated, in some implementations, call sequences may be dynamically adjusted (e.g., substantially in real time), for example in response to new data received at the smart intercom system, such as call metadata (e.g., call metadata 120E of FIG. 1B), video data (e.g., video data 120G of FIG. 1B), and/or access controller data (e.g., access controller data 120H). A dynamic adjustment to a call sequence can include, for example, modifying a first call sequence by (1) adding a receiver identifier (e.g., an identification number, a phone number, etc.) associated with a receiver, (2) increasing a priority (e.g., ordered position) of the receiver identifier within the call sequence, or (3) deleting the receiver identifier from the call sequence. In some embodiments, when all receivers in a given step of a call sequence fail to answer a call, the call sequence automatically progresses to the next step, as shown and discussed below with reference to FIG. 3.

FIG. 3 shows an example call sequence diagram for a smart intercom system, according to an embodiment. As shown in FIG. 3, the call sequence includes a predefined sequences of steps (302, 304, and 306) each specifying one or more receivers. During operation of the smart intercom system (e.g., as shown and described with reference to FIGS. 1A-1B), when a call is received via an intercom, the call is first routed, at step 302, to a first receiver (receiver A, which may be a phone such as a smartphone or land-line phone), and if the call is not answered by receiver A, the call is automatically re-routed by the smart intercom system to a second receiver (receiver B, which may be an app such as a mobile app). If the call is not answered by receiver B, step 302 is completed and the smart intercom system automatically proceeds to the next step in the call sequence (step 304), during which the smart intercom system re-routes the call to a third receiver (receiver C). If the call is then not answered by receiver C, step 304 is completed and the smart intercom system automatically proceeds to the next step in the call sequence (step 306), during which the smart intercom system re-routes the call to a fourth receiver (receiver D). When a call sequence does not manage to find any receiver (e.g., in the event that the call is not answered by receiver D in FIG. 3), the intercom system can be configured to execute an instruction to, or can be programmed to, play an “away” message (e.g., a voice message indicating that the business is not open, or that nobody is available, at that moment, optionally with a request for the caller/visitor to return at a specified future date) and/or notify relevant parties (e.g., by sending and/or causing a signal and/or message to be sent) via one or multiple of: Short Message Service (SMS), telephone call, email, mobile push notification, etc. In some embodiments, call sequences described herein can be edited via a cloud platform (e.g., hosted by cloud server(s) 114 of FIG. 1B), and any such edits to the call sequences may be immediately (e.g., substantially in real time) propagated/transmitted to the smart intercom system.

As described herein, the smart intercom system can be configured to reduce the number of calls dispatched to recipients who, for example, are unavailable to receive the call and/or who are scheduled to be absent. For example, the smart intercom system can be configured to remove an indication of a receiver from a call routing sequence based on (1) a badge event data indicating that the receiver is absent and/or (2) a status associated with a compute device of the receiver indicating that the receiver has not interacted with the compute device for at least a predefined period of time. As a result, the smart intercom system can prevent and/or reduce the initiation of calls that are likely to go unanswered by a recipient, which can conserve system resources such as network bandwidth and/or the like.

### Call Sequence Events/Playback

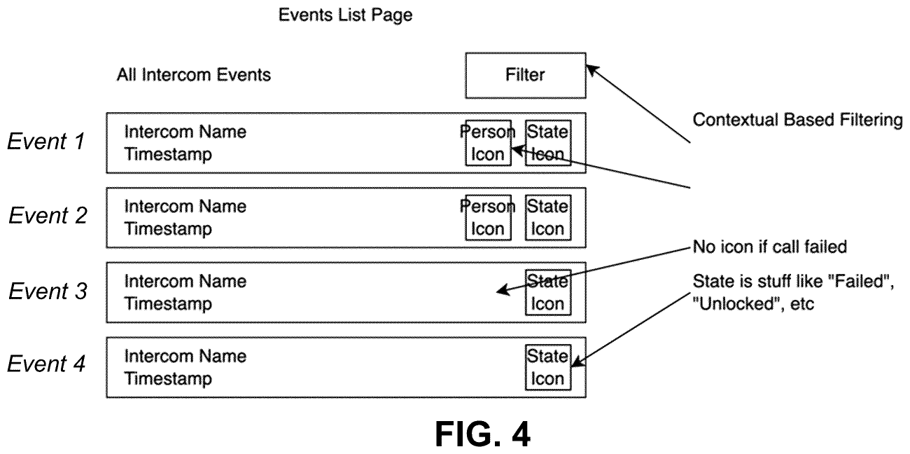

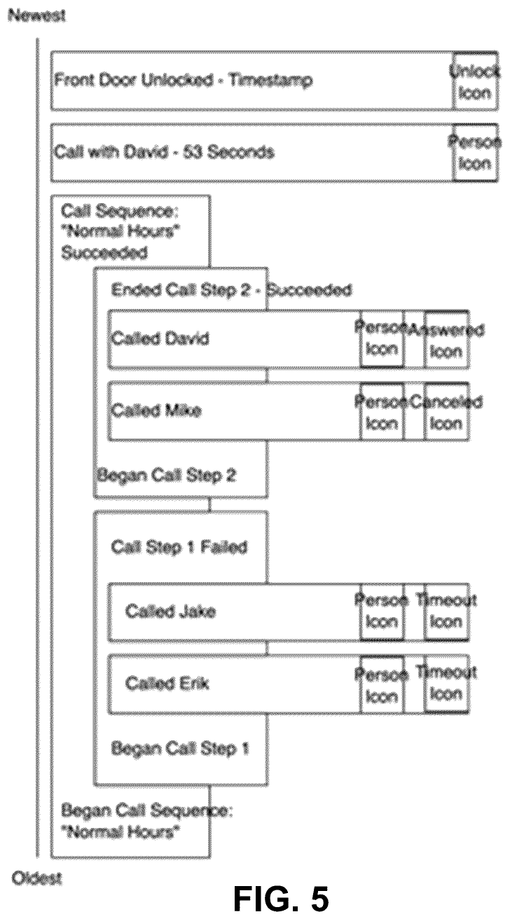

In some embodiments, representations of one or more events (e.g., event data 120I of FIG. 1B) are transmitted from a smart intercom system (e.g., smart intercom system 100B) to a cloud platform (e.g., a software platform hosted by cloud server(s) 114 of FIG. 1B) and can later be requested/retrieved and replayed, for example to assist a user in understanding what occurred during a historical call. FIG. 4 shows a call sequence events listing generated by a smart intercom system, according to an embodiment, and FIG. 5 shows an expanded view of a call sequence event, according to an embodiment. The call sequence events listing of FIG. 4 and/or the expanded view of the call sequence event in FIG. 5 may be presented to a user, for example, via a GUI/interface of the smart intercom system and/or via a GUI of a compute device associated with the user and the smart intercom system. The “Intercom Name” field appearing within each of Events 1 through 4 of FIG. 4 can refer to a single, unique intercom (e.g., all the same intercom), or each of Events 1 through 4 of FIG. 4 may indicate any intercom from a plurality of intercoms associated with a building or geographic region. As shown in FIGS. 4-5, information about whether a call was answered/picked up, who answered/picked up the call, and whether the person (i.e., the caller) was allowed to enter the building (among other information) is listed for a plurality of intercoms (e.g., all intercoms installed for a given building or geographic area). The events list can be filtered (see “FILTER” object in FIG. 4) by any available data, including: specific intercom, site, call state, call receiver, time of day, etc., e.g., in response to one or more user selections made via the interface. An individual event (e.g., any of Events 1 through 4 of FIG. 4) can be expanded, as shown in FIG. 5, such that the exact sequence of activities/actions associated with that event, including information such as timestamps and status, can be viewed by one or more users. In other words, FIG. 5 shows an expanded view of a single event (e.g., from Events 1 through 4 of FIG. 4).

### Call Sequence Scheduling

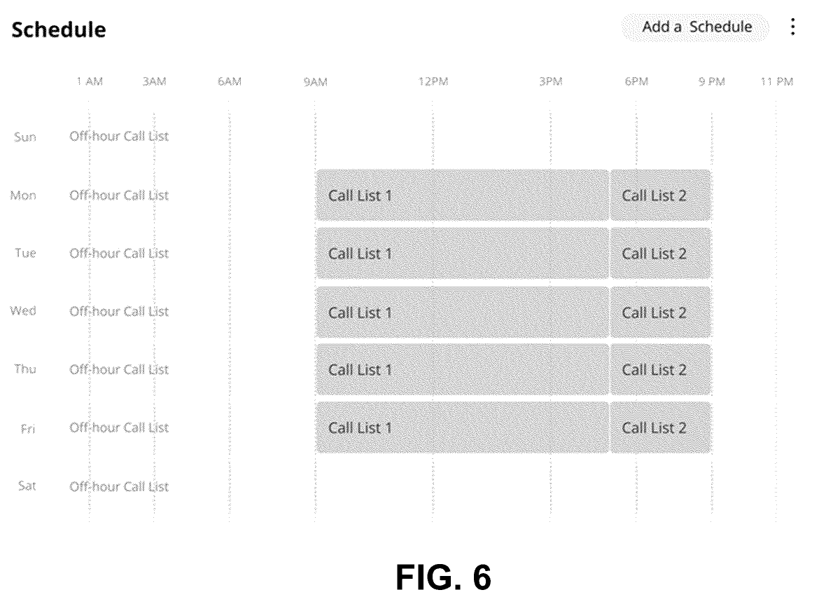

FIG. 6 shows an example call sequence scheduling interface for a smart intercom system, according to an embodiment. The call sequence scheduling interface of FIG. 6 may be presented to a user (e.g., a network administrator, a secretary, an employee, etc.), for example, via a GUI/interface of the smart intercom system and/or via a GUI of a compute device associated with the user and the smart intercom system. Individual call sequences can be scheduled, for example, based on day of week, time of day, etc. For example, as shown in FIG. 6, a predefined schedule (as indicated by schedule data) can specify that a first predefined call list (“Call List 1”) is to be implemented Monday through Friday from 9:00 am until 5:00 pm, and that a second predefined call list (“Call List 2”) is to be implemented Monday through Friday from 5:00 pm until 9:00 pm. The schedule data can include, for example, a lookup table and/or a mapping between (1) date and/or time data and (2) a pointer(s) to a call routing sequence(s). The smart intercom system can be configured to intelligently select, based on such a predefined schedule and a contemporaneous date and/or time (e.g., as indicated by the date/timestamp data 120J of FIG. 1), the call sequence to execute, and execute that selected call sequence, as discussed herein. Exceptions to schedules can also be predefined, e.g., for calendar based events such as holidays or other closure days (collectively referred to herein as “holidays”). In response to an exception (which can be indicated by schedule data received by the smart intercom system), the smart intercom system can be configured to modify a first predefined sequence by replacing the first predefined sequence with a second predefined sequence from a plurality of predefined sequences. Alternatively or in addition, custom schedules (e.g., for specific dates) may be predefined by users and/or automatically by the smart intercom system).

### Presence Aware Scheduling

In some embodiments, a smart intercom system of the present disclosure (e.g., smart intercom system 100A of FIG. 1A) can include one or more intercoms (e.g., intercom(s) 102 of FIG. 1A) that are integrated with one or more access control systems (e.g., access control system(s) 106 of FIG. 1A), and configured to perform “presence-aware scheduling.” For example, by ingesting presence data (e.g., data associated with a badge scan event, video data, image data, sensor data, etc.) at the access control system(s) through cross server application programming interfaces (APIs), the smart intercom system can “learn” or detect when a receiver (or a person associated with a receiver) has arrived in a particular location (e.g., an office) and dynamically add that receiver to a call sequence so that the receiver can receive routed/re-routed calls from the intercom. In other words, one or more call sequence schedules may be modified in response to the detected receiver. Similarly, presence-aware scheduling can be based on the detected departure of one or more receivers from one or more associated locations. The presence data can include, for example, an indicator (e.g., a binary indicator) that a person is located near the intercom. Alternatively or in addition, the presence data can include an identifier of the person (e.g., an employee identification number, government identification number, name, etc.), an identifier of a characteristic of the person (e.g., clothing worn by the person), and/or the like. This presence-aware scheduling is facilitated, for example, by the ability to dynamically adjust call sequences (e.g., substantially in real time) as well as access to the access control system(s) (which may be/include one or more “first party” access control systems).

### Intelligent Visitor Routing

In some embodiments, a smart intercom system of the present disclosure (e.g., smart intercom system 100A of FIG. 1A) can include one or more intercoms (e.g., intercom(s) 102 of FIG. 1A) that are integrated with, or that include, one or more computer vision models. For example, the computer vision model(s) may be running on one or more cameras of the one or more intercoms, one or more cameras co-located at one or more ingress locations (e.g., one or more exterior doors) associated with the one or more cameras, and/or on one or more security cameras elsewhere within a networked plurality of devices that includes the smart intercom system. Using the computer vision model(s) and the noted cameras, calls may be intelligently based on one or more observations about a visitor. In some such implementations, repeat visitors (e.g., visitors having been depicted and/or detected in a previous video stream(s)) may regularly be routed to/handled by the same receiver and/or forwarded to the same person or people based on their having been depicted and/or detected in a current video frame. Computer vision models can be used to detect patterns, and/or to present them (e.g., via a user interface) as quick options to receptionists or other users who receive/field/monitor the intercom calls. For example, if a delivery person arrives around the same time every day wearing a delivery uniform, the smart intercom system can learn to detect, using the computer vision model(s), that the delivery person has been allowed to enter a building in the past, and based on the detection of this information (e.g., a uniform color and/or a type of uniform worn by the delivery person and/or by another deliver person), automatically allow the delivery person into the building without a human/user needing to receive/intercept the call. The foregoing process, referred to herein as “intelligent visitor routing” (implemented, for example, by intelligent visitor routing rules) is facilitated, for example, by one or more of: (1) the intercom(s) running the same computer vision model(s) as the camera(s) (i.e., multiple compatible computer vision model(s)), (2) the intercom(s) and camera(s) communicating locally with one another, such that they are able to reach a consensus about the person being detected, (3) the ability to collect, via the smart intercom system (e.g., via a receiver application thereof), metadata about who is receiving a call, and/or (4) the ability to “tag” reoccurring visitors with metadata (e.g., caller profile data to specify that the detected person is a known delivery person).

### Intercom as an Access Controller

In some embodiments, a smart intercom system of the present disclosure (e.g., smart intercom system 100A of FIG. 1A) can include one or more intercoms (e.g., intercom(s) 102 of FIG. 1A) that are integrated with, or that include, one or more access control systems. Stated another way, one or more smart intercom systems set forth herein can act as a complete access control system. For example, a badge reader, door sensor and door locking mechanism can all be wired directly to an input/output (IO) interface of the intercom. In addition, information such as user profiles, door schedules, badge numbers, etc., can be added/populated (e.g., via a GUI) directly to a storage of the smart intercom system (e.g., to the intercom) such that the smart intercom system can subsequently evaluate access requests to unlock doors for users.

In some embodiments, a smart intercom system is configured to facilitate two-way communications (including audio and/or video) between a caller at an intercom and one or more receiver compute devices (e.g., smart phone, desk phone, tablet, web app, mobile app, etc.). In some implementations, a single smart intercom system manages one or multiple intercoms associated with a given building, group of buildings (e.g., a campus), or geographic area. In other implementations, multiple intercom systems can be used to manage one or multiple intercoms associated with a given building, group of buildings (e.g., a campus), or geographic area.

In some embodiments, a smart intercom system is configured to determine one or more device statuses (e.g., “Away” in Zoom) associated with one or more receivers and/or users associated with a call sequence, and dynamically adjust (e.g., modify) the call sequence based on the device statuses. For example, the smart intercom system may determine the one or more device statuses using an “ask” feature of one or more apps (e.g., to retrieve schedule data, access control data, etc.). Alternatively or in addition, the smart intercom system may determine the absence or presence of a receiver and/or user associated with a call sequence based on a history of whether the user has badged in since their last badge-out.

In some embodiments, a smart intercom system is configured to go to voicemail if an intercom call is not answered upon completion of a call sequence.

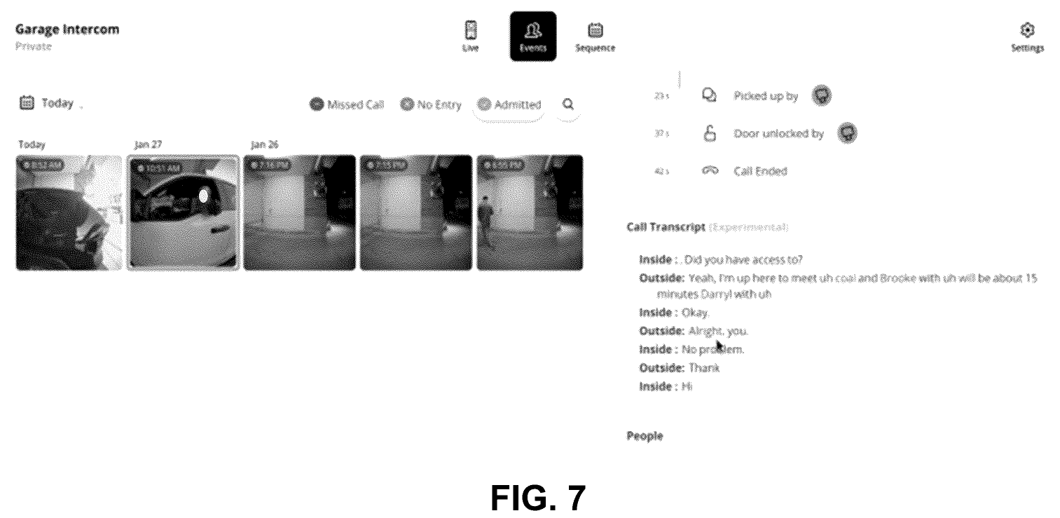

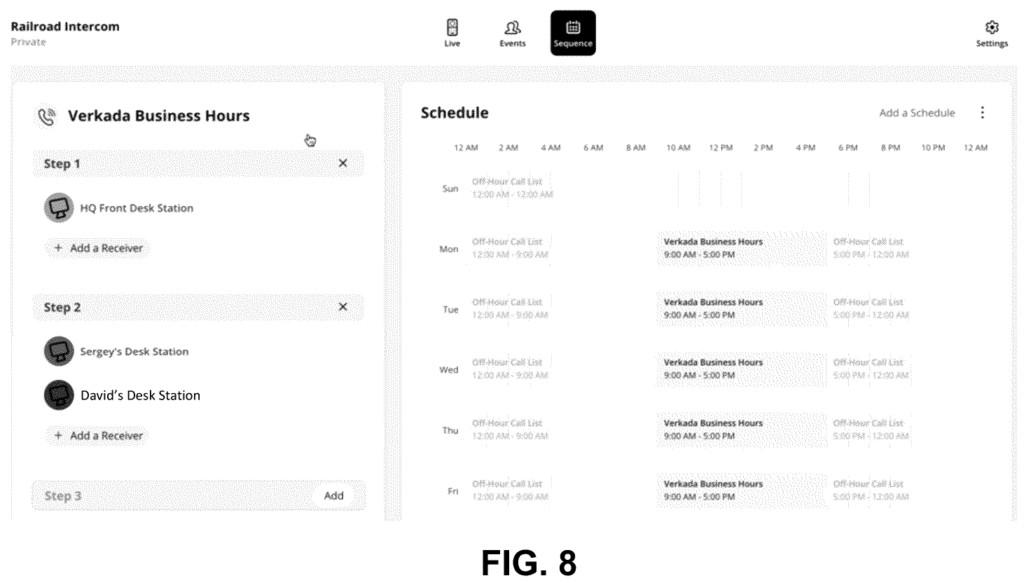

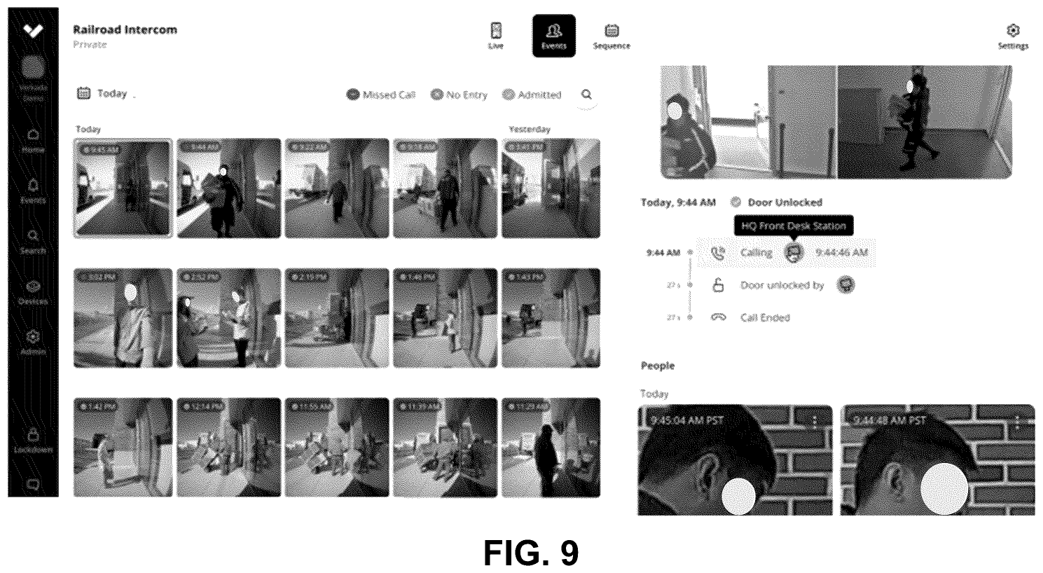

In some embodiments, a smart intercom system is configured to call multiple different client devices of a variety of different types. Alternatively or in addition, the smart intercom system can be configured to automatically change a call recipient (e.g., within a call sequence) based on contextual data (e.g., detection of a package possessed and/or being carried by a caller, and re-routing the call to a different receiver/recipient based on the detected package). Alternatively or in addition, the smart intercom system can be configured to perform call forwarding in response to speech recognition. Alternatively or in addition, the smart intercom system can be configured to perform, using facial recognition, a person of interest search on video/camera data. The person of interest search can include, for example, selecting a video frame and conducting people analytics to determine historical data associated with a person detected in the video frame (e.g., historical visit logs (dates, times) indicated by historical event data, roles/tags associated with the person, access control decisions associated with the person, etc.). Alternatively or in addition, the smart intercom system can be configured to perform auto-framing/auto-zooming of video imagery of an intercom caller. Alternatively or in addition, the smart intercom system can be configured to do a background check on an intercom caller, e.g., based on an image of their face, a form of identification of the intercom caller being displayed to a camera of the intercom, and/or historical caller profile data associated with the intercom caller. Alternatively or in addition, the smart intercom system can be configured to implement a talk down feature. For example, a building occupant (e.g., a receptionist) can converse with a visitor (e.g., who is positioned outside an entry of the building or who otherwise is physically/geographically remote from the building occupant) via a speaker and microphone that are operably coupled to the smart intercom system. FIGS. 7-9 are example user interface depicting functionalities of a smart intercom system, according to some embodiments.

In one or more embodiments, a smart intercom system can leverage the co-location and/or interconnectedness of a plurality of sensors and/or subsystems, such as camera(s), access control system(s), intercom(s), speaker(s), microphone(s), biometric sensor(s) (e.g., palm vein scanners, retinal scanners, etc.), facial recognition software, voice recognition software, and/or the like, to dynamically/reactively generate or modify a call routing sequence and/or to grant or modify access to a resource more efficiently than would otherwise be possible (e.g., using an individual component of the overall system), and/or may identify/classify visitors with a greater accuracy based on data from those sensors and/or subsystems (i.e., via sensor “fusion”). For example, a first camera of an intercom positioned at a building ingress may capture a facial image of a visitor and make a first determination, based on the facial image, as to the identity and/or legitimacy of the visitor. A second camera, positioned behind the visitor and in the vicinity of the building ingress may capture a full-body image of the visitor and make a second determination, based on the full-body image, as to the identity and/or legitimacy of the visitor. A voice recognition software can make a third determination, based on voice data collected by a microphone into which the visitor is speaking, as to the identity and/or legitimacy of the visitor. The smart intercom system can then generate or modify a call routing sequence and/or to grant or modify access to a resource (e.g., entry to the building) based on an analysis of the first determination, the second determination, and/or third determination. The analysis of the first determination, the second determination, and/or third determination can include prioritizing one or more predefined data types, attempting to reconcile pairs or subsets of the determinations, calculating one or more scores based on the three determinations and a visitor type/category, etc. For example, if the first determination and the second determination match (same identity is determined, and they agree that the visitor is legitimate) but the third determination conflicts (e.g., identity not recognized and/or the visitor legitimacy has a low associated confidence), entry to the building may be denied, or alternatively, additional data may be retrieved and taken into account by the smart intercom system (e.g., additional “safety measures” may be triggered). In other words, the smart intercom system may (optionally automatically, without human intervention) request or retrieve additional data from one or more sensors/data sources in response to identifying a conflict between two or more determinations as to the identity and/or legitimacy of the visitor. For example, the smart intercom system may prompt the visitor to repeat their name into the microphone, in an attempt to capture a higher-quality voice sample, re-run the voice recognition software, and then recalculate the third determination as to the identity and/or legitimacy of the visitor, which may in turn result in granting the visitor access/entry to the building. Although described above as involving three determinations as to the identity and/or legitimacy of the visitor (based on associated sensors and/or subsystems), any other number of determinations is also contemplated (e.g., two determinations, or four or more determinations).

In some implementations, the smart intercom system can be configured to generate a call routing sequence and/or grant access based on, for example, a combination of at least two of video data collected using the one or more cameras, voice data collected using the intercom, and/or schedule data. For example, the smart intercom system can use (1) a first machine learning model to classify a visitor based on video and/or image data that depicts the visitor and (2) a second machine learning model to classify a visitor based on audio (e.g., speech) data collected from the visitor via a microphone of the intercom. The first machine learning model and the second machine learning model can be jointly trained, such that their respective outputs (e.g., classifications) can be associated with a common and/or equivalent vector space. As a result of the common and/or equivalent vector space, the classifications of the first machine learning model and the second machine learning model can be compared. For example, the first machine learning model can classify the visitor as a delivery person based on a uniform worn by the visitor and/or a package possessed by the visitor. Alternatively or in addition, the first machine learning model can classify the visitor as a specific individual based on facial recognition. The second machine learning model can classify the visitor as a delivery person based on, for example, audio data that represents a statement made by the visitor and received at the microphone (e.g., “I work for FedEx® and I have a package to deliver”). Alternatively or in addition, the second machine learning model can classify the visitor as a specific individual based on speech patterns within the audio data.

The smart intercom system can be configured to compare the respective classifications of the first machine learning model and the second machine learning model to verify the identity of the visitor. For example, if each of the first machine learning model and the second machine learning model generates an output that indicates that the visitor works for UPS®, the smart intercom system can (1) configure the call routing sequence to include an indication of a shipping and receiving department and/or (2) grant the visitor access to a warehouse. If, however, the first machine learning model generates a first classification that indicates that the visitor is plain-clothed, and the second machine learning model generates an output that indicates that the visitor works for UPS® (e.g., as a result of the visitor falsely claiming that they work for UPS®), the smart intercom system can be configured to, for example, (1) play a message to the visitor that instructs the visitor to wait and/or (2) cause an alert to be sent to security indicating that the presence of suspicious visitor. In some implementations, the smart intercom system can be configured to verify a classification(s) generated by the first machine learning model and/or the second machine learning model based on the schedule data. For example, the smart intercom system can verify a delivery person classification for a visitor based on the date and/or time of the visit occurring within predefined business hours (e.g., between 9 am and 5 pm on weekdays).

In some implementations, the smart intercom system can be configured to generate a confidence score associated with a classification(s) generated by the first machine learning model and/or the second machine learning model. For example, if, as depicted in the video data, a visitor's face is occluded (e.g., because the visitor is wearing a mask, hat, etc.) and/or the visitor is not depicted clearly (e.g., due to low lighting, poor image quality, etc.), a confidence score associated with a classification from the first machine learning model can be low (e.g., below a threshold value). As a result, the smart intercom system can be configured to select the classification generated by the second machine learning model as the predicted classification for the visitor.

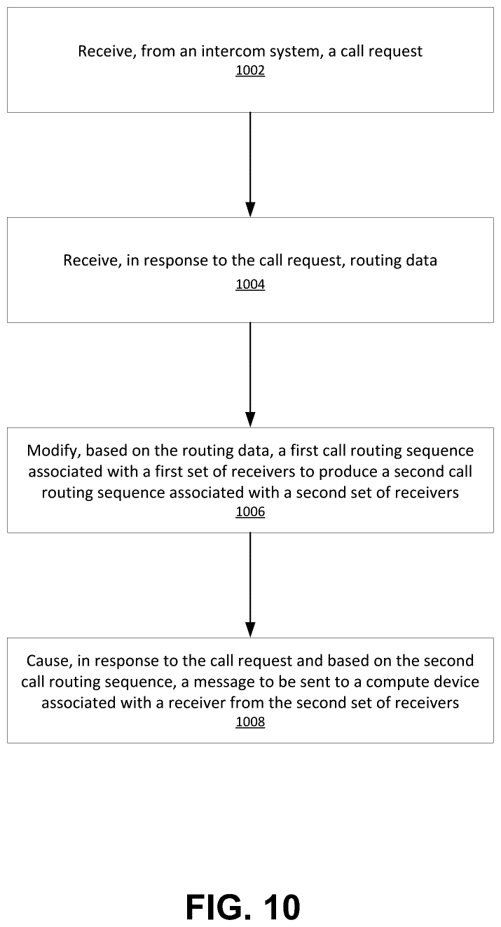

FIG. 10 shows a flow diagram illustrating a method 1000 for using a smart intercom system to modify a call routing sequence, according to an embodiment. The method 1000 can be implemented by, for example, the smart intercom system 100A of FIG. 1A and/or the smart intercom system 100B of FIG. 1B. At 1002, the method 1000 includes receiving, from an intercom system, a call request. The method 1000 at 1006 includes modifying, based on the routing data, a first call routing sequence associated with a first set of receivers to produce a second call routing sequence associated with a second set of receivers. At 1008, the method 1000 includes causing display, via a graphical user interface operably coupled to the processor, of a depiction of a modified call routing sequence that is generated based on a predefined call routing sequence and the at least one of the badge event data or the video data.

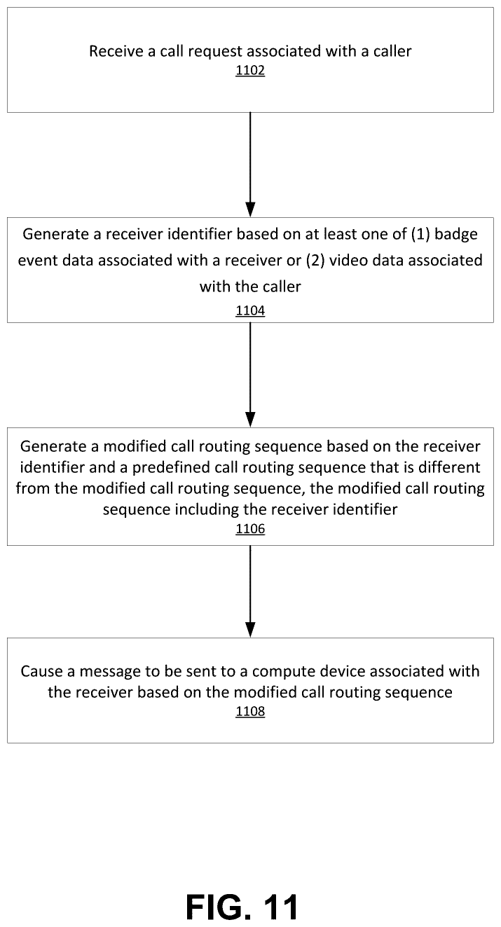

FIG. 11 shows a flow diagram illustrating a method 1100 for using a smart intercom system to cause a message to be sent based on at least one of (1) badge event data associated with a receiver or (2) video data associated with the caller, according to an embodiment. The method 1100 can be implemented by, for example, the smart intercom system 100A of FIG. 1A and/or the smart intercom system 100B of FIG. 1B. At 1102, the method 1100 includes receiving a call request associated with a caller. The method 1100 at 1104 includes generating a receiver identifier based on at least one of (1) badge event data associated with a receiver or (2) video data associated with the caller. At 1106, the method 1100 includes generating a modified call routing sequence based on the receiver identifier and a predefined call routing sequence that is different from the modified call routing sequence, the modified call routing sequence including the receiver identifier. the method 1100 at 1108 includes causing a message to be sent to a compute device associated with the receiver based on the modified call routing sequence.

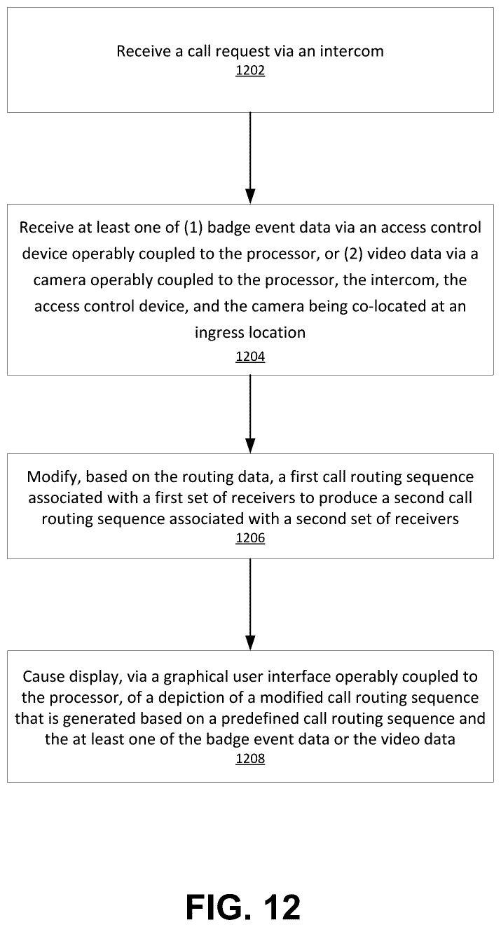

FIG. 12 shows a flow diagram illustrating a method 1200 for using a smart intercom system to cause display of a depiction of a modified call routing sequence, according to an embodiment. The method 1200 can be implemented by, for example, the smart intercom system 100A of FIG. 1A and/or the smart intercom system 100B of FIG. 1B. The method 1200 at 1202 includes receiving a call request via an intercom. At 1204, the method 1200 includes receiving at least one of (1) badge event data via an access control device operably coupled to the processor, or (2) video data via a camera operably coupled to the processor, the intercom, the access control device, and the camera being co-located at an ingress location. The method 1200 at 1206 includes modifying, based on the routing data, a first call routing sequence associated with a first set of receivers to produce a second call routing sequence associated with a second set of receivers. At 1208, the method 1200 includes causing display, via a graphical user interface operably coupled to the processor, of a depiction of a modified call routing sequence that is generated based on a predefined call routing sequence and the at least one of the badge event data or the video data.

In some embodiments, an apparatus includes a processor and a memory operably coupled to the processor. The memory stores instructions to cause the processor to receive, from an intercom system, a call request and receive, in response to the call request, routing data. The memory also stores instructions to cause the processor to modify, based on the routing data, a first call routing sequence associated with a first set of receivers to produce a second call routing sequence associated with a second set of receivers. Additionally, the memory stores instructions to cause the processor to cause, in response to the call request and based on the second call routing sequence, a message to be sent to a compute device associated with a receiver from the second set of receivers.

In some implementations, the memory can further store instructions to cause the processor to receive a video stream including a series of video frames and generate, using a computer vision model, caller profile data associated with a person depicted in at least one video frame from the series of video frames. Additionally, the instructions to cause the processor to receive the routing data can include instructions to receive the caller profile data, and the instructions to cause the processor to modify the first call routing sequence can include instructions to, based on the caller profile data, one of add a receiver identifier associated with the receiver to the first call routing sequence or increase a priority of the receiver identifier in the first call routing sequence.

In some implementations, the intercom system can further include a video camera operably coupled to the processor, the video stream being generated by the video camera. In some implementations, the instructions to cause the processor to generate the caller profile data can include instructions to generate metadata based on the person having been depicted in a previous video stream received from the intercom system. Additionally, the instructions to cause the processor to modify the first call routing sequence can include instructions to one of add a receiver identifier associated with the receiver to the first call routing sequence or increase a priority of the receiver identifier in the first call routing sequence, based on the metadata.

In some implementations, the caller profile data can be associated with at least one of a uniform worn by the person or a package possessed by the person. In some implementations, the memory can further store instructions to send a signal to cause a background check to be performed based on the caller profile data. In some implementations, the routing data can include presence data associated with the receiver. Additionally, the instructions to cause the processor to modify the first call routing sequence can include instructions to one of add a receiver identifier associated with the receiver to the first call routing sequence or increase a priority of the receiver identifier in the first call routing sequence, based on the presence data. In some implementations, the presence data can be associated with a badge scan event.

In some implementations, the presence data can be generated using at least one of facial recognition or speech recognition. In some implementations, the routing data can include schedule data. Additionally, the instructions to cause the processor to modify the first call routing sequence can include instructions to replace, based on the schedule data, the first call routing sequence with the second call routing sequence selected from a plurality of predefined call routing sequences that includes the first call routing sequence and the second call routing sequence. In some implementations, the memory can further store instructions to cause the processor to modify the second call routing sequence based on the schedule data indicating a holiday. In some implementations, the message can indicate a future return date based on the schedule data.

In some implementations, the routing data can include status data associated with the compute device. Additionally, the instructions to cause the processor to modify the first call routing sequence can include instructions to, based on the status data, one of add a receiver identifier associated with the receiver to the first call routing sequence or increase a priority of the receiver identifier in the first call routing sequence. In some implementations, the message can be associated with at least one of Short Message Service (SMS), a telephone call, an email, or a mobile push notification.

In some embodiments, a non-transitory, processor-readable medium stores instructions that, when executed by a processor, cause the processor to receive a call request associated with a caller. The instructions also cause the processor to generate a receiver identifier based on at least one of (1) badge event data associated with a receiver or (2) video data associated with the caller. Additionally, a modified call routing sequence is generated based on the receiver identifier and a predefined call routing sequence that is different from the modified call routing sequence. The modified call routing sequence includes the receiver identifier. The instructions also cause the processor to cause a message to be sent to a compute device associated with the receiver based on the modified call routing sequence.

In some implementations, the instructions to generate the receiver identifier include instructions to generate the receiver identifier based on a predefined schedule of receiver availability. In some implementations, the instructions to cause the message to be sent can include instructions to cause the message to be sent to at least two compute devices associated with at least receivers identified by the modified call routing sequence. In some implementations, the non-transitory, processor-readable medium can further store instructions to cause the processor to delete at least one receiver identifier from at least one of the predefined call routing sequence or the modified call routing sequence based on at least one of the badge event data or status data. In some implementations, the video data can depict the caller at least one of (1) wearing a uniform or (2) in possession of a package. Additionally, the instructions to generate the receiver identifier can include instructions to detect, using a computer vision model and based on the video data, at least one of the uniform or the package. In some implementations, the instructions to generate the receiver identifier can include instructions to generate the receiver identifier based on historical event data associated with the caller.

In some embodiments, an apparatus includes a processor and a memory operably coupled to the processor. The memory stores instructions to cause the processor to receive a call request via an intercom operably coupled to the processor and further receive at least one of (1) badge event data via an access control device operably coupled to the processor, or (2) video data via a camera operably coupled to the processor, the intercom, the access control device, and the camera being co-located at an ingress location. Additionally, the instructions cause the processor to cause display, via a graphical user interface operably coupled to the processor, of a depiction of a modified call routing sequence that is generated based on a predefined call routing sequence and the at least one of the badge event data or the video data.

All combinations of the foregoing concepts and additional concepts discussed herewithin (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus, comprising:
a processor; and
a memory operably coupled to the processor, the memory storing instructions to cause the processor to:
receive, from an intercom system, a call request,
receive, in response to the call request, routing data,
modify, based on the routing data, a first call routing sequence associated with a first set of receivers to produce a second call routing sequence associated with a second set of receivers, and
cause, in response to the call request and based on the second call routing sequence, a message to be sent to a compute device associated with a receiver from the second set of receivers.

2. The apparatus of claim 1, wherein:
the memory further stores instructions to cause the processor to:
receive a video stream including a series of video frames, and
generate, using a computer vision model, caller profile data associated with a person depicted in at least one video frame from the series of video frames;
the instructions to cause the processor to receive the routing data include instructions to receive the caller profile data; and
the instructions to cause the processor to modify the first call routing sequence include instructions to, based on the caller profile data, one of add a receiver identifier associated with the receiver to the first call routing sequence or increase a priority of the receiver identifier in the first call routing sequence.

3. The apparatus of claim 2, wherein the intercom system further comprises a video camera operably coupled to the processor, the video stream being generated by the video camera.

4. The apparatus of claim 2, wherein:
the instructions to cause the processor to generate the caller profile data include instructions to generate metadata based on the person having been depicted in a previous video stream received from the intercom system; and
the instructions to cause the processor to modify the first call routing sequence include instructions to one of add a receiver identifier associated with the receiver to the first call routing sequence or increase a priority of the receiver identifier in the first call routing sequence, based on the metadata.

5. The apparatus of claim 2, wherein the caller profile data is associated with at least one of a uniform worn by the person or a package possessed by the person.

6. The apparatus of claim 2, wherein the memory further stores instructions to send a signal to cause a background check to be performed based on the caller profile data.

7. The apparatus of claim 1, wherein:
the routing data includes presence data associated with the receiver; and
the instructions to cause the processor to modify the first call routing sequence include instructions to one of add a receiver identifier associated with the receiver to the first call routing sequence or increase a priority of the receiver identifier in the first call routing sequence, based on the presence data.

8. The apparatus of claim 7, wherein the presence data is associated with a badge scan event.

9. The apparatus of claim 7, wherein the presence data is generated using at least one of facial recognition or speech recognition.

10. The apparatus of claim 1, wherein:
the routing data includes schedule data; and
the instructions to cause the processor to modify the first call routing sequence include instructions to replace, based on the schedule data, the first call routing sequence with the second call routing sequence selected from a plurality of predefined call routing sequences that includes the first call routing sequence and the second call routing sequence.

11. The apparatus of claim 10, wherein the memory further stores instructions to cause the processor to modify the second call routing sequence based on the schedule data indicating a holiday.

12. The apparatus of claim 10, wherein the message indicates a future return date based on the schedule data.

13. The apparatus of claim 1, wherein:
the routing data includes status data associated with the compute device; and
the instructions to cause the processor to modify the first call routing sequence include instructions to, based on the status data, one of add a receiver identifier associated with the receiver to the first call routing sequence or increase a priority of the receiver identifier in the first call routing sequence.

14. The apparatus of claim 1, wherein the message is associated with at least one of Short Message Service (SMS), a telephone call, an email, or a mobile push notification.

15. A non-transitory, processor-readable medium storing instructions that, when executed by a processor, cause the processor to:
receive a call request associated with a caller;
generate a receiver identifier based on at least one of (1) badge event data associated with a receiver or (2) video data associated with the caller;
generate a modified call routing sequence based on the receiver identifier and a predefined call routing sequence that is different from the modified call routing sequence, the modified call routing sequence including the receiver identifier; and
cause a message to be sent to a compute device associated with the receiver based on the modified call routing sequence.

16. The non-transitory, processor-readable medium of claim 15, wherein the instructions to generate the receiver identifier include instructions to generate the receiver identifier based on a predefined schedule of receiver availability.

17. The non-transitory, processor-readable medium of claim 15, wherein the instructions to cause the message to be sent include instructions to cause the message to be sent to at least two compute devices associated with at least receivers identified by the modified call routing sequence.

18. The non-transitory, processor-readable medium of claim 17, further storing instructions to cause the processor to delete at least one receiver identifier from at least one of the predefined call routing sequence or the modified call routing sequence based on at least one of the badge event data or status data.

19. The non-transitory, processor-readable medium of claim 15, wherein:
the video data depicts the caller at least one of (1) wearing a uniform or (2) in possession of a package; and
the instructions to generate the receiver identifier include instructions to detect, using a computer vision model and based on the video data, at least one of the uniform or the package.

20. The non-transitory, processor-readable medium of claim 15, wherein the instructions to generate the receiver identifier include instructions to generate the receiver identifier based on historical event data associated with the caller.

21. An apparatus, comprising:
a processor; and
a memory operably coupled to the processor, the memory storing instructions to cause the processor to:
receive a call request via an intercom operably coupled to the processor;
receive at least one of (1) badge event data via an access control device operably coupled to the processor, or (2) video data via a camera operably coupled to the processor, the intercom, the access control device, and the camera being co-located at an ingress location; and
cause display, via a graphical user interface operably coupled to the processor, of a depiction of a modified call routing sequence that is generated based on a predefined call routing sequence and the at least one of the badge event data or the video data.
